(19) United States
(12) Patent Application Publication
(10) Pub. No.: US 2015/0300164 A1
(43) Pub. Date: Oct. 22, 2015

(54) SENSING APPARATUS, METHOD, AND APPLICATIONS

(71) Applicant: FAZ TECHNOLOGY LIMITED, Dublin (IE)

(72) Inventors: Steven Frey, Orlando, FL (US); Charles Willliams, Oviedo, FL (US); Matthew Comstock, Orlando, FL (US); Mohammad Umar Piracha, Orlando, FL (US); Clark Davis Boyd, Blacksburg, VA (US); Samuel Mark Dippold, Christiansburg, VA (US)

(73) Assignee: FAZ TECHNOLOGY LIMITED, Dublin (IE)

(21) Appl. No.: 14/691,647

(22) Filed: Apr. 21, 2015

Related U.S. Application Data
(60) Provisional application No. 61/982,411, filed on Apr. 22, 2014.

(51) Int. Cl. E21B 49/08; G01K 11/32; G01L 11/02; G02B 6/34

(52) U.S. Cl. CPC E21B 49/087; G02B 6/34; G01K 11/32; G01L 11/025

(57) ABSTRACT

An optical fiber-based sensor assembly in the form of a cable assembly that can measure at least both pressure characteristics and temperature characteristics of a pressurized fluid in a channel in which the sensor cable assembly is disposed.

This application claims priority to U.S. Provisional application No. 61/982,411 filed Apr. 22, 2014, the subject matter of which is incorporated herein in its entirety.

Embodiments of the invention pertain generally to the field of sensors; more particularly, to optical fiber-based sensors; and most particularly to optical fiber-based sensors to measure characteristics of a fluid including but not limited to temperature and/or pressure and/or flow of a fluid in a channel (e.g., wellbore, tube, conduit, pipe, etc.).

In applications including but not limited to, e.g., Steam Assisted Gravity Drainage (SAGD), steam (which may be at high temperature) is injected into a wellbore at high pressure for crude oil and bitumen recovery. In this and other applications, it may be desirable to monitor certain characteristics of the fluid in the channel such as, e.g., temperature and/or pressure and/or flow parameters, or changes thereof, at various locations in or along the channel.

Conventional sensors (e.g., fiber-based sensors) may be capable of capturing temperature data of a fluid (e.g., steam) flow at a given location in a channel (e.g., wellbore); however, it would be advantageous to measure desired characteristics of the fluid at any given point or at multitude of points in the channel, or continuously along the channel. Furthermore, it would be advantageous to acquire the desired characteristics measurements with sufficient resolution for the intended purpose(s) of the measurement(s) and likely, higher resolution than provided by conventional sensors and methods. Particularly, but by example only, manufacturers and operators of subterranean wellbores that utilize high temperature and high pressure fluid in the wellbore would benefit from apparatus and methods that enable high resolution measurements of temperature, pressure, flow rate, and other characteristics of the pressurized fluid in the wellbore.

### Definitions as Used Herein

The term ‘channel’ refers to a physical wellbore, tube, conduit, pipe, or other structure that can contain and/or propagate a pressurized fluid, certain characteristics of which are intended to be measured by or with the use of the embodied invention.

The term ‘capillary tube’ refers to a known tube component of an upper wellbore of a conventional SAGD upper and lower wellbore structure, having an outer diameter of nominally 0.25 inch.

The term ‘about’ means the amount of the specified quantity plus/minus a fractional amount (e.g., ±10%, ±9%, ±8%, ±7%, ±6%, ±5%, ±4%, ±3%, ±2%, ±1%, etc.) thereof that a person skilled in the art would recognize as typical and reasonable for that particular quantity or measurement.

The term ‘substantially’ means as close to or similar to the specified term being modified as a person skilled in the art would recognize as typical and reasonable; for e.g., within typical manufacturing and/or assembly tolerances, as opposed to being intentionally different by design and implementation.

The aspects and embodiments of the invention will be disclosed, for convenience, in the framework of a horizontal wellbore as is known in the art of Steam Assisted Gravity Drainage (SAGD); however, it is to be clearly understood that the embodied invention is not so limited to this application and accompanying structures.

The most general aspect of the invention is an optical fiber-based sensor in the form of a cable assembly that can measure at least both pressure characteristics and temperature characteristics of a pressurized fluid in a channel in which the sensor cable assembly is disposed. In a SAGD application, the sensor cable assembly is disposed in a capillary tube having, typically, a nominal inner diameter of 0.25 in. The capillary tube may be pre-disposed in the wellbore prior to placement of the sensor cable assembly therein or, the sensor cable assembly may be disposed in the capillary tube, which capillary tube is subsequently disposed in the wellbore. An aspect of the embodied cable design combines pressure and temperature measurements based on, in a non-limiting embodiment, calibrated FBGs in a single optical cable, which can be installed in the capillary tube of a SAGD wellbore already down-hole. The pressure measurement FBGs are embedded in an outer perimeter of the cable bundle and the temperature measurement FBGs are embedded in the center of the cable bundle in a pres sure-resistant shroud for cable structural integrity.

An aspect of the invention is an optical fiber sensor assembly that includes an optical fiber-based temperature sensor having a length; a circumferential shroud within which the length of the optical fiber-based temperature sensor is disposed, wherein the shroud is characterized by a minimum pressure resistance; a circumferential expandable membrane within which the shroud is disposed, having a longitudinal axis; and an optical fiber-based pressure and/or strain sensor having a length disposed on an outer circumferential surface of the expandable membrane, wherein the optical fiber-based pressure and/or strain sensor is characterized by a protective covering. According to various exemplary, non-limiting embodiments, the optical fiber sensor assembly may include the following additional features, limitations, and/or characteristics alone or in combination:

wherein the minimum pressure resistance of the shroud is sufficient to prevent a radial deformation of the shroud in a pressurized environment in which it is deployed;
wherein the circumferential expandable membrane is characterized by a controllable radial expansion and contraction;
wherein the sensor assembly has an annular space intermediate an outer surface of the shroud and an inner surface of the expandable membrane wherein a pressurized fluid can be disposed;
wherein at least a portion of the length of the optical fiber-based pressure and/or strain sensor is oriented along the longitudinal axis and at least another portion of the length of the optical fiber-based pressure and/or strain sensor is oriented at an angle to the longitudinal axis;
wherein the protective covering of the optical fiber-based pressure and/or strain sensor is a continuous circumferential layer of material;
wherein the protective covering of the optical fiber-based pressure and/or strain sensor is a ribbon coating;
wherein the protective covering of the optical fiber-based pressure and/or strain sensor is a glue-like coating;
wherein the protective covering of the optical fiber-based pressure and/or strain sensor is a mesh coating;
wherein the optical fiber-based temperature sensor comprises a fiber Bragg grating (FBG);
wherein the optical fiber-based temperature sensor comprises a multicore fiber;
wherein the optical fiber-based pressure and/or strain sensor comprises a FBG;
wherein the optical fiber-based pressure and/or strain sensor comprises a multicore fiber;
wherein the optical fiber-based temperature sensor comprises a plurality of optical fiber-based temperature sensors disposed along a longitudinal axis of the shroud;

wherein a spacing of at least some of the FBGs in one of the optical fiber-based temperature sensors is not uniform along a length of the sensor assembly with respect to another of the optical fiber-based temperature sensors;

wherein the optical fiber-based pressure and/or strain sensor comprises a plurality of optical fiber-based pressure sensors oriented substantially co-parallel
wherein the sensor assembly is characterized by an external diameter that is less than an internal diameter of a capillary tube disposed in a channel in which a characteristic of a pressurized fluid is to be measured in a deactivated state and that is equal to the internal diameter of the tube in an activated state.

An aspect of the invention is a sensing method that includes the steps of providing a sensor assembly that includes an optical fiber-based temperature sensor having a length; a circumferential shroud within which the length of the optical fiber-based temperature sensor is disposed, wherein the shroud is characterized by a minimum pressure resistance; a circumferential expandable membrane within which the shroud is disposed, having a longitudinal axis; and an optical fiber-based pressure sensor having a length disposed on an outer circumferential surface of the expandable membrane, wherein the optical fiber-based pressure sensor is characterized by a protective covering and wherein the sensor assembly has an annular space intermediate an outer surface of the shroud and an inner surface of the expandable membrane wherein a pressurized fluid can be disposed, disposed in a capillary tube that is disposed in a channel in which a characteristic of a pressurized fluid is to be measured; and injecting/removing a different pressurized fluid into the annular space to radially expand/contract the expandable membrane against/away from an inner surface of the capillary tube.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

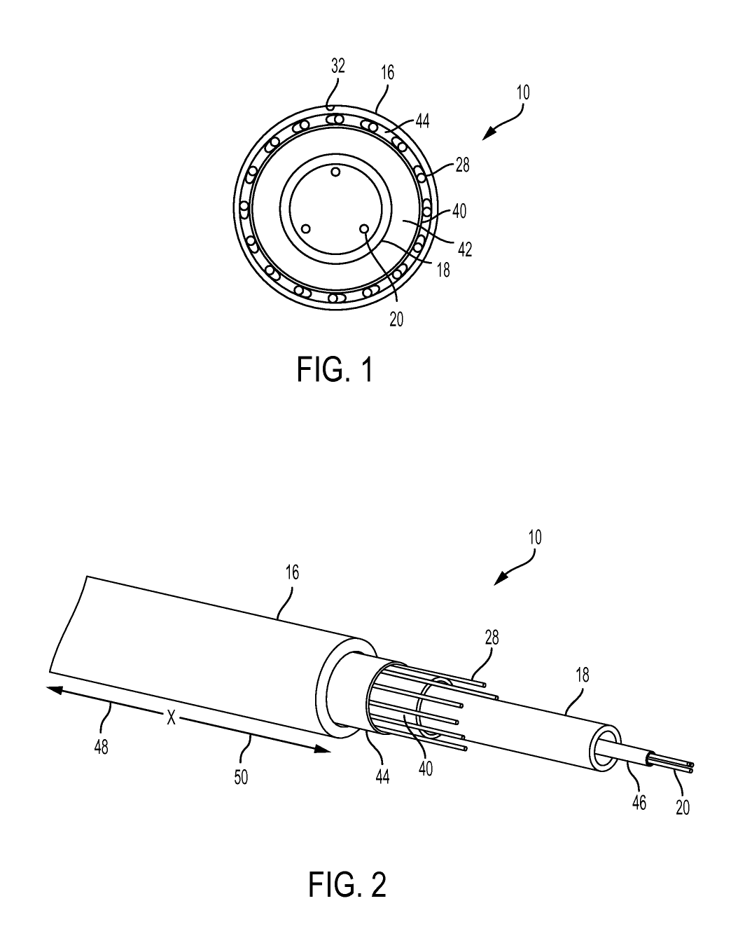

FIG. 1 shows a schematic end cross sectional view of an optical fiber sensor assembly in a capillary tube, according to an exemplary embodiment of the invention.

FIG. 2 shows a schematic perspective view of the optical fiber sensor assembly illustrated in FIG. 1, according to an illustrative embodiment of the invention.

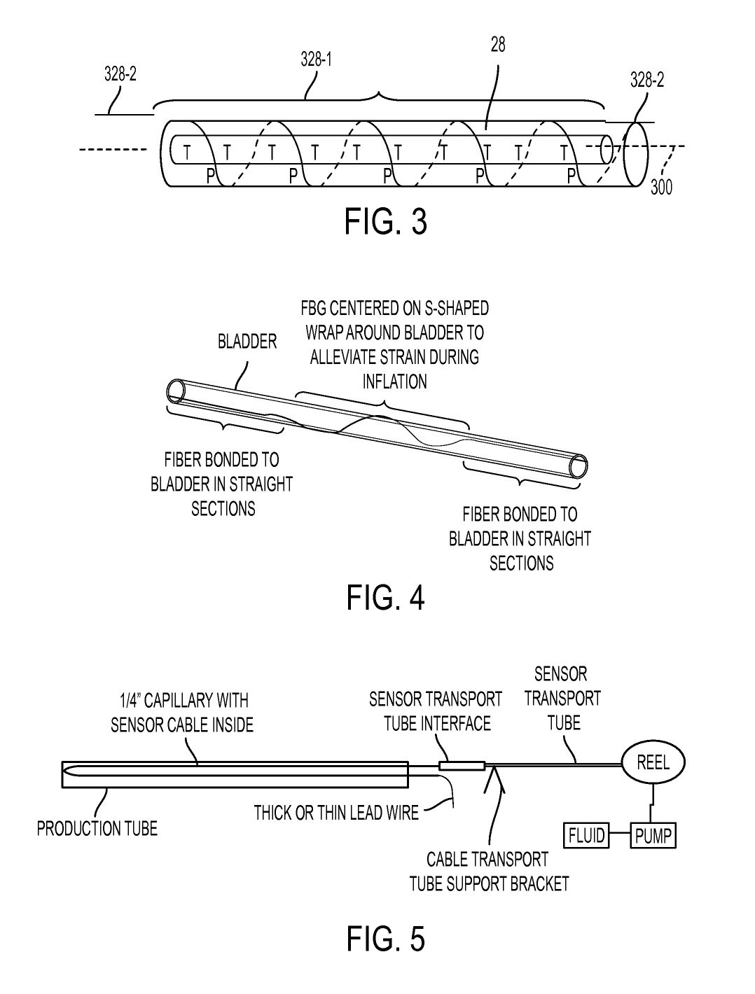

FIG. 3 shows a schematic 3-D view of a portion of the optical fiber sensor assembly illustrated in FIG. 1, according to an illustrative aspect of the invention.

FIG. 4 shows a schematic 3-D view of a portion of the optical fiber sensor assembly according to an illustrative aspect of the invention.

FIG. 5 schematically illustrates details of an installation design of the optical fiber sensor assembly in a capillary tube, according to an illustrative aspect of the invention.

FIG. 1 shows an end cross sectional view of an optical fiber sensor assembly 10 disposed in a capillary tube 16, which capillary tube is not a part of the invention per se. The illustrated sensor assembly in the form of a cable includes three (one to 20 or more may be used depending upon application parameters) optical fiber-based temperature sensors 20 each having a given length. The optical fiber-based temperature sensors 20 may be conventional, commercially available optical fiber Bragg grating (FBG) temperature sensors. Alternatively, the optical fiber-based temperature sensors 20 may be multi-core fiber temperature sensors that accurately measure temperature or strain via changes in the fiber using reflected or transmitted laser energy. The optical fiber-based temperature sensors 20 extend longitudinally within a circumferential shroud 18. The shroud is made of a suitable material (e.g., metal, composite, plastic, other) that provides desired structural rigidity to the sensor assembly and which isolates/protects the temperature sensor fibers from the high pressure of the fluid outside the capillary tube that they are temperature sensing and the down-hole pressure (for clarification, the primary function of the shroud is for a strength member for the cable; i.e., to resist the pressure of the fluid pumped into the annular region so that it does not press the fibers against each other). The shroud may further be filled with a similar thixotropic fluid in order to both assist the shroud in resisting deformation due to pressure outside the shroud and to provide thermal conductivity to the fiber temperature sensors contained within. Circumferentially adjacent the shroud is an expandable membrane 40. There is an annular space 42 between the shroud and the expandable membrane. The expandable membrane 40 is made of a material (e.g., DuPont's Kalrez) that can radially expand and contract in response to pressure exerted against its inner surface, as further described below. A plurality of optical fiber-based pressure sensors 28 are disposed around the outer surface of the expandable membrane and are embedded in and/or covered by a protective layer of material 44. The optical fiber-based pressure sensors 28 may be conventional, commercially available optical fiber Bragg grating (FBG) pressure sensors. The protective layer of material 44 may be circumferentially continuous and may be made, e.g., similarly to the expandable membrane, of DuPont's Kalrez, which is capable of expanding under pressure. Alternatively, the pressure sensing fibers may be embedded in, e.g., a glue-like coating or a Teflon ribbon coating. Length portions 328-2 (see FIG. 3) of the fiber pressure sensor 28 before and after the FBG region 328-1 thereof are oriented along the longitudinal axis 300 of the sensor assembly (being the same as the longitudinal axes of the shroud and the expandable membrane). The FBGs would ideally be oriented along the inner circumference of the capillary tube in order to be directly coupled to the hoop stress and strain generated by the compression of the capillary tube under external pressure. However, the bend radius required to orient the fiber in this manner around a 0.25 in. capillary tube would exceed the minimum allowable bend radius of the fiber. Therefore, to increase the bend radius to acceptable levels, the FBG region 328-1 of the pressure sensing fiber 28 is wrapped around the expandable membrane at an angle relative to the longitudinal axis 300 of the expandable membrane as illustrated in FIGS. 3 and 4.

Pressure measurements are based on directly measuring the strain on the outer capillary tube wall created by the steam pressure/movement around the capillary tube in the wellbore. To activate the expandable membrane, a lubricant (or other suitable thixotropic fluid with a specific gravity close to that of optical fiber) that operates at high temperature is introduced into the annular space 42 between the shroud and the expandable membrane. The pressure of the lubricant causes the radial expansion of the expandable membrane and forces the FBGs of the pressure sensing fibers against the inner surface of the capillary tube. The expandable membrane can be deactivated via a controller at the head end and allowed to deflate for cable removal without extracting the capillary tube from the wellbore. FIG. 3 further illustrates the temperature FBGs in the center of the optical cable and the pressure FBGs against the wall of the capillary tube.

The angle of the pressure sensing FBG wrap with respect to the longitudinal axis 300 will allow a portion of the strain in the capillary tube to be coupled into the pressure sensing FBGs. This is given by the equation: ε_{FBG}=εsinθ, where θ is the angle measured from the longitudinal axis. For example, a FBG at an angle of 45° will measure 70.7% of the strain. The fiber between the FBGs is oriented longitudinally along the expandable membrane to prevent this passive fiber from being overstrained when the membrane is expanded. Because the pressure sensing FBGs are not oriented longitudinally, they will be subjected to strain during expansion of the membrane. To prevent overstraining, extra fiber can be included near the FBGs in the form of an S-shaped curved as illustrated in FIG. 4. As the membrane is expanded, the S curve will provide slack in the fiber to prevent overstraining.

The optical sensor assembly is designed such that it can be inserted through an existing capillary tube that is pre-inserted in a SAGD wellbore and removed/reinserted at a later time when desired. With reference to FIG. 5, a pre-installation procedure for pulling the cable is as follows:
Pump thin capillary lead wire through ¼″ capillary;
Pull thick capillary lead wire through ¼″ capillary with the thin capillary lead wire;
Pull capillary forming tool through the ¼″ capillary tube, increasing forming as needed;
Pull the capillary gage-block through the ¼″ capillary tube, reform if needed, re-gage if needed;

Once that is accomplished, an installation procedure may be conducted as follows:
Position the sensor cable reel system to allow direct translation of sensor cable end to ¼″ capillary in a relatively straight line or with gradual bends for insertion of sensor cable into ¼″ capillary;
Position sensor cable transport tube support bracket and affix the sensor cable transport tube;
Remove the sensor cable transport tube end cover and stow it;
Attach the sensor transport tube interface, thick capillary lead wire, pump system, fluid and reservoir;
Adjust pump pressure to translate cable into the ¼″ capillary while pulling with the thick capillary lead wire;
When the sensor cable is fully inserted, attach sensor fill port to the pump system;
Complete well head sensor seal;
Attach interrogator system optical fiber and begin measurement recording;
Fill the sensor with fluid. While this is happening, key calibration points for the pressure sensor fibers will be measured and validated;
Pressure cycle fill fluid as needed.

In an illustrative aspect, the pressure sensors could be spaced at one every 10 m along the length of the capillary tube. With as many as 20 FBGs per fiber, the longest horizontal well would require only five temperature fibers per kilometer of horizontal extent for spatial resolution of one FBG per 10 meters.

In operation, the optical fiber sensor assembly will be coupled to one or more interrogators as known in the art and operated accordingly. Various fluids, reservoirs, pumps, and other equipment necessary for system operation as known in the art, and not part of the invention per se, will be provided.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

We claim:

1. An optical fiber sensor assembly, comprising:
an optical fiber-based temperature sensor having a length;
a circumferential shroud within which the length of the optical fiber-based temperature sensor is disposed,
wherein the shroud is characterized by a minimum pressure resistance;
a circumferential expandable membrane within which the shroud is disposed, having a longitudinal axis; and
an optical fiber-based pressure sensor having a length disposed on an outer circumferential surface of the expandable membrane,
wherein the optical fiber-based pressure sensor is characterized by a protective covering.

2. The sensor assembly of claim 1, wherein the minimum pressure resistance of the shroud is sufficient at least to prevent a radial deformation of the shroud in a pressurized environment in which it is deployed.

3. The sensor assembly of claim 1, wherein the circumferential expandable membrane is characterized by a controllable radial expansion and contraction.

4. The sensor assembly of claim 1, wherein the sensor assembly has an annular space intermediate an outer surface of the shroud and an inner surface of the expandable membrane wherein a pressurized fluid can be disposed.

5. The sensor assembly of claim 1, wherein at least a portion of the length of the optical fiber-based pressure sensor is oriented along the longitudinal axis and at least another portion of the length of the optical fiber-based pressure sensor is oriented at an angle to the longitudinal axis.

6. The sensor assembly of claim 1, wherein the protective covering of the optical fiber-based pressure sensor is a continuous circumferential layer of material.

7. The sensor assembly of claim 1, wherein the protective covering of the optical fiber-based pressure sensor is a ribbon coating.

8. The sensor assembly of claim 1, wherein the protective covering of the optical fiber-based pressure sensor is a glue-like coating.

9. The sensor assembly of claim 1, wherein the protective covering of the optical fiber-based pressure sensor is a mesh coating.

10. The sensor assembly of claim 1, wherein the optical fiber-based temperature sensor comprises a fiber Bragg grating (FBG).

11. The sensor assembly of claim 1, wherein the optical fiber-based temperature sensor comprises a novel fiber sensor that accurately measure temperature or strain via changes in the fiber using reflected or transmitted laser energy, such as multicore fibers[reference?].

12. The sensor assembly of claim 1, wherein the optical fiber-based pressure sensor comprises a FBG.

13. The sensor assembly of claim 10, wherein the optical fiber-based temperature sensor comprises a plurality of optical fiber-based temperature sensors disposed along a longitudinal axis of the shroud.

14. The sensor assembly of claim 12, wherein the optical fiber-based pressure sensor comprises a plurality of optical fiber-based pressure sensors oriented substantially co-parallel.

15. The sensor assembly of claim 1, wherein the sensor assembly is characterized by an external diameter that, in a deactivated state, is less than an internal diameter of a capillary tube disposed in a channel in which a characteristic of a pressurized fluid is to be measured, and that is equal to the internal diameter of the tube in an activated state.

16. The sensor assembly of claim 13, wherein a spacing of at least some of the FBGs in one of the optical fiber-based temperature sensors is not uniform along a length of the sensor assembly with respect to another of the optical fiber-based temperature sensors.

17. The sensor assembly of claim 14, wherein a spacing of at least some of the FBGs in one of the optical fiber-based pressure sensors is not uniform along a length of the sensor assembly with respect to another of the optical fiber-based pressure sensors.

18. A sensing method, comprising:
providing the sensor assembly of claim 4 disposed in a capillary tube that is disposed in a channel in which a characteristic of a pressurized fluid is to be measured; and
injecting/removing a different pressurized fluid into the annular space to radially expand/contract the expandable membrane against/away from an inner surface of the capillary tube.
